(19) United States
(12) Patent Application Publication
(10) Pub. No.: US 2026/0004367 A1
(43) Pub. Date: Jan. 1, 2026

(54) SATELLITE IMAGING DATA FOR ENHANCED PRODUCTION OF PLANT PROPAGATION MATERIAL

(71) Applicant: BASF SE, Ludwigshafen am Rhein (DE)

(72) Inventors: Thomas CHRISTEN, Limburgerhof (DE); Joerg HUENNINGHAUS, Ludwingshafen am Rhein (DE); Christoph LOEFFEL, Limburgerhof (DE); Eduardo NEVES, Durham, NC (US); Stephane POUZADOUX, Ecully (FR)

(21) Appl. No.: 18/880,746

(22) PCT Filed: Jun. 22, 2023
(86) PCT No.: PCT/EP2023/067001

§ 371 Date: Jan. 2, 2025

(30) Foreign Application Priority Data
Jul. 1, 2022 (EP) 22182539.1

(51) Int. Cl. G06Q 50/02; G06V 10/764; G06V 20/10; G06V 20/13

(52) U.S. Cl. CPC G06Q 50/02; G06V 10/764; G06V 20/13; G06V 20/188

(57) ABSTRACT

The invention relates to a computer-implemented method for selecting at least one agricultural field for production of plant propagation material of a crop plant by utilizing historic satellite imaging data of at least one agricultural field from at least one previous growing period; a system configured to carry out said method; the use of the historic imaging data of an agricultural field of a previous growing period in said method; and a computer program element and a computer readable medium for carrying out the method.

### TECHNICAL FIELD

The present disclosure relates to a computer-implemented method for selecting at least one agricultural field for production of plant propagation material of a crop plant by using historic satellite imaging data of a field from at least one previous growing period. Further objects are the use of historic satellite imaging data of an agricultural field of a previous growing period for said method; a system configured to carry out said method; as well as a computer readable medium and a computer program element configured to carry out said method.

### TECHNICAL BACKGROUND

In modern agriculture, crop plants with high performance under various conditions are grown by farmers. The crop plants have complex sets of traits that enable them to cope with all kinds of adverse external conditions, such as drought, lack of nutrients, competition from weeds, fungal diseases, insect infestation and so forth. They may also carry traits that enable modern agricultural techniques like herbicide tolerances, which enables the selective control of weeds by broad-spectrum herbicides. Further high-performance crop plants are generated by hybridization of parental lines to produce the so-called heterosis effect in the first filial generation (F1). Farmers buy seeds, roots, shoots, and other propagation material from suppliers, who produce said propagation material on agricultural fields by crossing of suitable parental lines, or reproduction of propagation material.

In the production of crop propagation material, such as seeds, it is utmost importance to generate a genetically pure product that contains as little off-spec material as possible. Clearly, any off-spec material bears the risk for the farmer that an undesirable effect is observed regarding the share of off-spec material. For example, BASF is producing different kinds of herbicide-tolerant crops under the tradename Clearfield. If a farmer buys such a Clearfield product, e.g. corn, it is expected that the corn plants grown from the marketed corn seeds have certain herbicide tolerances. Accordingly, the farmer would expect the crop plants to be fit for herbicide applications, such as burn-down treatments with herbicides without inflicting any harm to the crop plants grown for the Clearfield seeds. However, if the seeds contain a non-herbicide-tolerant impurity of 5-10%, the farmer will harvest approximately 5-10% less corn than expected under the prevailing conditions because the non-tolerant corn plants will suffer from the phytotoxic effect of the herbicide just as the weed plants.

In turn, suppliers of plant propagation material need to make sure that they only generate a product with none to very little impurities. A major source of impurities are non-suitable production sites. If an agricultural field had been used to grow crop plants of the same species in a previous growing period, plant propagation material not harvested after said previous growing period remains on the field, such as in the soil. Accordingly, the plant propagation material will germinate in the present growing period and produce propagation material again by asexual propagation or crossing events with the crop plants to be grown in the running season. This may generate a considerable amount of off-spec material in the final product. Equally detrimental to the quality of the plant propagation product are crop plants of the same species as the propagation material, which are growing on adjacent or close-by fields. The pollen of such crop plants is transported by wind or insect to the field where the propagation material is to be produced and cause sexual crossing of the plants. Again, the generated propagation material will in this case to a considerable amount not contain the desired traits. This causes financial damage to the farmer and a damage to the reputation of the supplier and producer of the crop propagation material.

Accordingly, it would be desirable to provide a tool for producers of plant propagation material for selecting at least one agricultural field for production of plant propagation material of a crop plant to mitigate said risks.

This goal has been achieved by a computer-implemented method (100) for selecting at least one agricultural field for production of plant propagation material of a crop plant comprising the steps:
a) providing historic satellite imaging data of at least one agricultural field from at least one previous growing period to a processing unit (101);
b) determining, based on the imaging data, if the crop plant was grown on the at least one field in at least one previous growing period by the processing unit (102);
c) providing information by the processing unit if the crop plant had been grown on the at least one field in at least one previous growing period (103);
d) selecting, based on the provided information, at least one suitable agricultural field for production of plant propagation material, wherein the crop plant has not been grown on the at least one agricultural field for at least one previous growing period (104).

It was surprisingly found that historic satellite imaging data can be used with an extremely high accuracy to identify the type of crop plant that had been grown on the agricultural field over a previous growing period. Accordingly, the tool enables a selection which agricultural field would be suitable for the production of plant propagation material of a certain crop plant. These and other objects, which become apparent upon reading the following description, are solved by the subject matter of the independent claims. The dependent claims refer to preferred embodiments of the invention.

### SUMMARY OF THE INVENTION

In one aspect of the present disclosure, the invention relates to computer-implemented method (100) for selecting at least one agricultural field for production of plant propagation material of a crop plant comprising the steps:
a) providing historic satellite imaging data of at least one agricultural field from at least one previous growing period to a processing unit (101);
b) determining, based on the imaging data, if the crop plant was grown on the at least one field in at least one previous growing period by the processing unit (102);
c) providing information by the processing unit if the crop plant had been grown on the at least one field in at least one previous growing period (103);
d) selecting, based on the provided information, at least one suitable agricultural field for production of plant propagation material, wherein the crop plant has not been grown on the at least one agricultural field for at least one previous growing period (104).

Another aspect relates to the use of historic satellite imaging data of an agricultural field of a previous growing period as defined in any of the preceding claims in a method as defined in any of the preceding claims.

A third aspect relates to a system for selecting an agricultural field for seed production of a crop plant, the system comprising
a) a receiving unit configured to receive historic imaging data of at least one agricultural field from at least one previous growing period (101);
b) a processing unit configured to
   determine, based on the imaging data, if the crop plant had been grown on the at least one field in at least one previous growing period (102);
   provide information if the crop plant had been grown on the at least one field in at least one previous growing period (103); and
   select, based on the provided information, at least one suitable agricultural field for production of plant propagation material, wherein the crop plant has not been grown on the at least one agricultural field for at least one previous growing period (104).

A fourth aspect relates to a computer program element with instructions, which, when executed on computing devices of a computing environment, is configured to carry out the steps of the above method in the above system. A fifth aspect relates to a computer readable medium having stored said computer program element.

Any disclosure and embodiments described herein relate to the methods, the systems, the methods of use, the computer program element and/or the computer readable medium lined out above and vice versa. Advantageously, the benefits provided by any of the embodiments and examples equally apply to all other embodiments and examples and vice versa.

The present disclosure is based on the finding that historic satellite imaging data of a field at a previous growing period can be used to determine if a certain type of crop plant, e.g. a certain plant species, had been grown on an agricultural field during a previous growing season. This information can be used to select a suitable production site for generating plant propagation material, e.g. seeds.

### Definitions

The term (agricultural) field relates to an arable piece of land where crop plants, such as fruits and vegetables, or row crops such as corn or rapeseed are grown and/or were grown for at least one previous growing season. In connection to step b), i.e. determining if the crop plant had been grown on the at least one field, the term “field” includes both the entire field and parts thereof, such as half of an agricultural field or a third thereof. Agricultural field does not relate to covered facilities such as greenhouses. The location of the at least one agricultural field may be provided by a human user or may be retrieved from a GPS signal. For example, the location of the GPS data points representing at least one of a field boundary and field center coordinates may be used to determine the geographical location of the field. Accordingly, a first agricultural field, or several agricultural fields of interest where it is envisaged that plant propagation material is to be grown is either provided by a human input, or from GPS signals. In turn, satellite imaging data of said field(s) are retrieved. In addition, satellite imaging data for adjacent or remote agricultural fields may be retrieved as described below.

The term plant propagation material relates to all kinds of reproductive plant material, such as seeds, roots, and shoots. In a preferred embodiment, plant propagation material relates to seeds, in particular to seeds of the plant family Brassicacaea, such as Brassica napus, and Sinapis alba, especially Brassica napus. The term crop plant relates to a plant that is obtained by growing the plant propagation material. Accordingly, the term crop plant typically also relates to a plant of the family Brassicacaea, such as Brassica napus and Sinapis alba, especially Brassica napus.

The term previous growing period relates to the last or a previous period during a growing season during which an agricultural field was farmed, i.e. during which a crop plant was grown or during which a grass or clover is grown in a crop rotation system. Depending on the location of the agricultural field, more than one growing period may be contained in one growing season. The term “at least one previous growing period” typically relates to the last growing period before the current or upcoming growing period. In one embodiment, the term “at least one previous growing period” relates to the previous two, three, four, five, or up to ten growing periods before the current or upcoming growing period. In one embodiment, the term “at least one previous growing period” relates to at least the last 3, preferably at least the last 5 previous growing periods. In one embodiment, the term previous growing period relates to at least the last two previous growing periods.

The term “adjacent (agricultural) field(s)” relates to two fields that share at least one common boundary, which are separated by a street, a river, or any other human or natural object that is not larger than 50 meters by its horizontal dimension on the ground.

The term machine-learning algorithm has to be understood broadly and preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for several records of input data that higher by many orders of magnitude.

As used herein, the term “crop” may refer to a plant such as a grain, fruit, or vegetable grown in large amounts. Preferred crops are: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Ribes sylvestre, Ricinus communis, Saccharum officinarum, Secale cereale, Sinapis alba, Solanum tuberosum, Sorghum bicolor (S. vulgare), Theobroma cacao, Trifolium pratense, Triticum aestivum, Triticale, Triticum durum, Vicia faba, Vitis vinifera and Zea may. Most preferred crops are: Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (S. vulgare), Triticale, Triticum aestivum, Triticum durum, Vicia faba, Vitis vinifera and Zea mays.

As used herein “determining” also includes “initiating or causing to determine”, “generating” also includes “initiating or causing to generate” and “providing” also includes “initiating or causing to determine, generate, select, send or receive”. “Initiating or causing to perform an action” includes any processing signal that triggers a computing device or processing unit to perform the respective action.

As used in the term “determining [ . . . ] by a/the processing unit”, the “determining” relates to an automatic determination performed by the processing unit without human interaction.

The computer-implemented method (100) contains step a) of providing historic satellite imaging data of at least one agricultural field from at least one previous growing period to a processing unit (101). This step is typically achieved by providing historic satellite imaging data of at least two agricultural field, preferably even a bigger area, like an entire geographic region, a country or state.

The method may typically include a step a1) of determining field boundaries in the historic satellite imaging data (101a). This step may typically be carried out after step a) and before step b). However, it is also possible to perform step a1) after step b) and before step c). Such a determination may be achieved by a field boundary detection model. Field boundary detection models are typically obtained by using supervised machine-learning. Suitable machine-learning approaches include deep learning techniques, in particular the use of convolutional neural networks for segmentation, e.g. UNet or ResUNet-a (Diakogiannis, F. I., Waldner, F., Caccetta, P., Wu, C., 2019. Resunet-a: a deep learning framework for semantic segmentation of remotely sensed data. arXiv preprint arXiv:1904.00592; https://www.tensorflow.org/).

Training images for these supervised machine-learning approaches should be as homogeneous as possible by selecting the observation with least cloud coverage from a specified interval, e.g. within 3 months. Gaps in the selected observation due to clouds may be filled with other, unclouded observations. This approach may generate images which are both complete and have a minimum of artificial disturbances in the image which would occur freely combining images from different observation dates. Additionally, to indicate artificial disturbances from replacements to the model, an extra layer encoding the time of observation of each pixel may be created. Thus, the model can learn to identify disturbances. Furthermore, Sobel filters applied to the individual satellite bands are typically generated, to enhance the visibility of optical edges in the image.

The chosen training data in vector format is typically rasterized to match the satellite data. Three different targets may be derived to train the model as described in Waldner et al. (Deep learning on edge: extracting field boundaries from satellite images with a convolutional neural network; 2020; arXiv preprint arXiv:1910.12023v2): a binary mask of the field boundaries, a binary mask of the extent of the fields and a field-wise normalized distance (distance to closest boundary).

To train the models, satellite data and training data may be sliced down to smaller portions (e.g. 128×128 pixel images) to fit into GPU memory. The models, which are based on the tensorflow library (www.tensorflow.org), are typically optimized by minimizing Tanimoto loss (see Waldner, F., Diakogiannis, F. I., 2020: Deep learning on edge: extracting field boundaries from satellite images with a convolutional neural network. arXiv preprint arXiv:1910.12023v2).

The trained segmentation models may then be used to derive field boundary predictions and field extent predictions for targeted new areas. They typically make use of the mechanisms previously described for the training process. Satellite images are chosen, preprocessed, and sliced down to generate the input for inference. Inference is performed independently on multiple timepoints of one or multiple seasons to mitigate altering appearances of agricultural fields due to vegetative processes throughout the year. Afterwards, those predictions on slices are rejoined to larger units (tiles).

The field boundary predictions may be finally combined to generates field boundaries in vector format. The individual predictions of an area at different time points may be merged (e.g. via mean or max operation), artificially magnified to a higher resolution (e.g. from 10 m to 2 m) and smoothed. The magnification allows the system to compensate for the effects of the coarse pixels of satellite data yielding smoother field boundaries. The probabilistic model predictions with continuous values from 0 to 1 are classified by thresholds to yield binary values. Subsequently, these binary masks may then be combined to a final field boundary mask by subtracting the binary field boundary predictions from the binary field extent predictions. Finally, the segments in raster format are vectorized and minor adjustments may be performed, like smoothing of the boundaries and filling smaller gaps in fields. The obtained field boundaries are stored on a file storage and referenced in a database, to allow for easy access and usage.

In one embodiment, the historic satellite imaging data comprises time-resolved imaging data over the at least one previous growing period. The term time-resolved imaging data relates to a series of imaging data captured over a historic growing period. The accuracy of the inventive objects as described herein increases by the number of measurements per growing period. Typically, one set of imaging data of a field per week is captured over a growing period.

In one embodiment, step b) comprises determining from the imaging data time-resolved vegetation index data selected from Normalized Difference Vegetation Index (NDVI) Data and/or Leaf Area Index (LAI) Data, Normalized Difference Water Index (NDWI), Enhanced Vegetation Index (EVI) Data and/or any other vegetation-based indices data. Such vegetation indexes and their calculation from satellite images are known to the skilled person and have for example been described in https://en.wikipedia.org/wiki/Vegetation_Index or in https://earthobservatory.nasa.gov/features/MeasuringVegetation/measuring_vegetation_2.php.

In one embodiment, step b) comprises classifying the at least one field by crop plant according to the time-resolved vegetation index data. The classification typically involves the assignment of the crop plants grown on a field to a particular plant species, or at least a plant genus or family.

It has been discovered that the classification of plants grown on an agricultural field can be made with high accuracy from satellite imaging data, especially from time-resolved imaging data, such as from time-resolved vegetation index data.

Accordingly, it is possible to determine, by means of a processing unit, which kind of plant is grown on an agricultural field. The processing unit performs said task by using a classification model. The classification model is obtainable by various methods, such as machine-learning, especially supervised learning. Techniques useful for supervised learning to yield classification models are logistic regression, a perceptron algorithm, Bayes classification, naïve Bayes classification, k-nearest neighbor algorithm, artificial neural networks and decision-tree based modeling such as random forest algorithms. Training data for generating suitable models is typically obtained by annotation of satellite imaging data with ground truth data, which may for example be gathered by agronomic advisors, users, or field-based machinery such as the BASF Smart Sprayer.

Highest accuracy of the prediction is typically achieved by using time-resolved vegetation index data, but it is equally possible to use a single satellite image of an agricultural field to determine the type of crop plant growing on it.

In case a vegetation index is used, a single index like the NDVI or the LAI index might be sufficient. However, a combination of various vegetation indexes does of course increase the accuracy of the determination considerably.

Other methods useful in step b) are a wide range of statistical modelling approaches. For example, satellite images indexed with ground truth data may be used to generate calibration curves for certain crop plants. These calibration curves may then be used in regression analysis to classify new satellite imaging data.

The accuracy achievable with such methods is typically at least 90%, usually at least 95%. A high accuracy of the determination of step b) is particularly important since even a small error would cause considerable insecurities if a high number of agricultural fields are assessed. Accordingly, the determination in step b) would first result in a certain probability that a crop plant was grown on the agricultural field. This information may be provided in step c) directly. Alternatively, the agricultural field may be classified based on a pre-defined benchmark as a field where the crop plant had or had not been grown during at least one previous growing period, and this classified information may then be provided in step c).

The inventive method is used for selecting an agricultural field for production of plant propagation material of a crop plant comprising step d) of selecting, based on the provided information, a suitable agricultural field for production of plant propagation material, wherein the crop plant has not been grown on the agricultural field for at least one previous growing period (104).

The term “selecting at least one agricultural field” is typically performed by a processing unit, which may be the same or a different one as used in steps a)-c), preferably the same. In case the selection is performed by the same processing unit, step c) of providing the determined information just relates to the use of the determined information of step b) as an input for the selection process of step d) by the processing unit. In case the selection of step d) is performed by another processing unit, the processing unit provides the determined information of step c) to said other processing unit. In this case, the processing units would usually be communicatively coupled to exchange said information. In one embodiment, the selection of step d) is performed by a human user.

The term “selecting at least one agricultural field” includes the selection of a number of agricultural fields that are suitable for production of plant propagation material of the crop plant if said information in step b) is determined for more than one field. The selection is carried out based on the information if the crop plant, which can be grown for the propagation material to be produced, had been grown on the at least one field in at least one previous growing period. If only satellite imaging data of one field is provided in step a), and the determination of step b) relates to only one field, the selection of a suitable field may simply result in the selection of the one field analyzed, or in the selection of no field if it is determined in step b) that the crop plant had already been grown on said field during at least one previous growing period.

In one embodiment, the method comprises a step e) of outputting information on the selection of step d) or the information if the crop plant had been grown on the at least one field of step c). The term “outputting” may refer to an electronic signal that may by output via an outputting interface, wherein the outputting interface is connectively or otherwise coupled to the processing unit(s) of steps b)/c) and d). The electronic signal may be used to display the information on a suitable user-interface receiving the electronic signal, such as a personal computer, a mobile phone, a tablet, a smart watch, virtual reality devices etc. In case the user directly receives the information of step c), i.e. the information if a crop plant had been grown on the at least one field in at least one previous growing period, the selection of the suitable agricultural field in step d) may be performed by the user based on the received information. The output of the selection of step d) may, however, be used in a subsequent step, preferably in an automated production system of plant propagation material, to perform production on the selected agricultural fields. For example, if an agricultural field has been identified to be useful for generating high-purity products, an automated planting device may be used to plant a said field with plant propagation material of the crop plant of interest. In this case, the automated planting device may typically be an autonomous mobile vehicle, such as a tractor.

In one embodiment, imaging data of at least two agricultural fields is provided, and wherein at least two of the agricultural fields are adjacent fields, or wherein the boundaries of at least two of the agricultural fields are up to 10 km apart; and wherein the selection of step d) is also based on the information on the presence of the crop plant at the at least one second field during a previous growing period.

Impurities in produced plant propagation material are mainly caused by a) remaining plant propagation material from previous growing periods in the soil of the agricultural field where the new batch of plant propagation material is to be produced, which grows into crop plants and is harvested together with the propagation material to be produced; and b) sexual crossing events of the crop plants producing the new batch of plant propagation material with crop plants with other plants to alter the genotype of the produced plant propagation material in an undesirable way.

Sexual crossing typically occurs by exchange of pollen via insects or wind. Accordingly, it is desirable to find an agricultural field that does not only have a history in which the same crop plant (same species, genus or at least family, preferably species) has not been grown on the field during at least one previous growing period itself, but which also does not have any agricultural field nearby where the crop plant (by species, genus or at least family, preferably species) had been grown during at least one previous growing period.

Accordingly, the method may include imaging data of at least one adjacent field and/or further remote fields to the field of interest. The distance of the remote field(s) and the field of interest depends on the desired purity of the produced propagation material, but is typically up to 10 kilometers, preferably up to 5 kilometers, more preferably up to 3 kilometers, especially up to 2 kilometers, such as up to 1 kilometer. For example, the typical flight radius of honeybees is up to 3 kilometers. In turn, if the crop plant of interest can be pollinated by honeybees, agricultural fields that are up to 3 kilometers apart from the field of interest should be considered.

In one embodiment, imaging data of one agricultural field and all adjacent fields is provided, wherein the selection of step d) is based on the information on the presence of the crop plant at the field and all adjacent fields during at least one previous growing period. The probability of sexual crossing by pollination decreases by the distance of crop plants. The adjacent fields to the field of interest are thus causing most impurities in the plant propagation material to be produced and it is advisable to at least monitor all directly adjacent agricultural fields.

In one embodiment, the imaging data is obtained by using Synthetic Aperture Radar (SAR), or Light Detection and Ranging (LIDAR) via satellites.

The method may comprise the additional step of outputting, by the processing unit, the provided information if the crop plant had been grown on the at least one field in at least one previous growing period, or on the selection of the at least one suitable agricultural field for production of plant propagation material, wherein the crop plant has not been grown on the at least one agricultural field for at least one previous growing period.

Another embodiment relates to the use of historic satellite imaging data of an agricultural field of a previous growing period as defined above in a method as defined above.

In another embodiment, the invention relates to a system for selecting an agricultural field for seed production of a crop plant, the system comprising
a) a receiving unit configured to receive historic imaging data of at least one agricultural field from at least one previous growing period (101);
a) a processing unit configured to
   determine, based on the imaging data, if the crop plant had been grown on the at least one field in at least one previous growing period (102);
   provide information if the crop plant had been grown on the at least one field in at least one previous growing period (103); and
   select, based on the provided information, at least one suitable agricultural field for production of plant propagation material, wherein the crop plant has not been grown on the at least one agricultural field for at least one previous growing period (104).

The receiving unit, and the processing unit are communicatively coupled, preferably the receiving and the processing unit have a connective interface. The connective interface may be a direct local connection, as achieved by an electric connection, local area networks, wireless connections etc, or the connection may be a long-range connection such as a connection over the internet, wide area networks, dial-in connections, cable modems etc.

The receiving unit is configured to receive historic imaging data of at least one agricultural field from at least one previous growing period to a processing unit. The receiving unit typically relates to a receiving interface that is connectively coupled to the processing unit. The receiving unit is capable of communicating with a remote device such as a data source computing device having stored thereon the original satellite imaging data captured by a satellite, or with a local or remote memory device having stored thereon the historic satellite imaging data. The data source computing device may be accessed via a web service or API (Application Programming Interface).

In one embodiment, the receiving unit may be a computing device itself comprising storage memory and a processing unit, such as a personal computer or a server, or it may be an electric interface of the precession unit as on a computing device or personal computer to receive the imaging data via short-range or long-range connections such as via the internet (e.g. from a cloud-based memory), via a LAN connection, a USB connection, a WLAN connection etc.

The processing unit is configured to determine, based on the imaging data, if the crop plant had been grown on the at least one field in at least one previous growing period (102), and to provide information if the crop plant had been grown on the at least one field in at least one previous growing period (103). The processing unit obtains the imaging data from the receiving unit to which it is communicatively coupled as mentioned above. The term processing unit typically relates to a general-purpose processing device such as a microprocessor, microcontroller, central processing unit, or the like. More particularly, the processing means may be a CISC (Complex Instruction Set Computing) microprocessor, RISC (Reduced Instruction Set Computing) microprocessor, VLIW (Very Long Instruction Word) microprocessor, or a processor implementing other instruction sets or processors implementing a combination of instruction sets. The processing means may also be one or more special-purpose processing devices such as an ASIC (Application-Specific Integrated Circuit), an FPGA (Field Programmable Gate Array), a CPLD (Complex Programmable Logic Device), a DSP (Digital Signal Processor), a network processor, or the like. The methods, systems and devices described herein may be implemented as software in a DSP, in a micro-controller, or in any other side-processor or as hardware circuit within an ASIC, CPLD, or FPGA. It is to be understood that the term “processing unit” or processor may also refer to one or more processing devices, such as a distributed system of processing devices located across multiple computer systems (e.g., cloud computing), and is not limited to a single device unless otherwise specified.

The processing unit is also configured to select, based on the information if the crop plant had been grown on the at least one field in at least one previous growing period, at least one suitable agricultural field for production of plant propagation material, wherein the crop plant has not been grown on the at least one agricultural field for at least one previous growing period (104). The processing unit may also be configured to output information on said selection (104). The processing unit may also be configured to output the information if the crop plant had been grown on the at least one field in at least one previous growing period.

The outputting is typically achieved via an outputting interface communicatively coupled to the processing unit. The outputting interface may be a human-machine interface. Accordingly, the processing means can then output, via the human-machine-interface the information of step c), or information on the selection of step d). A user can thus be informed about the suitability of at least one agricultural field, or on the selection of one or more suitable fields within a number of fields.

The human machine interface may comprise a video display unit (e.g. liquid crystal display), a cathode ray tube display, or a touch screen, and/or a signal generation device (e.g., a speaker). The human-machine interface thus can, for example, be a visual interface such as a screen and/or it can be an audio interface such as a loudspeaker. Accordingly, the output can either be displayed to the user and/or it can be announced via the speaker.

Thus, the process of informing the user selecting a suitable field can be made simple and intuitive for the user. For example, the devices can be intuitively coded, for example, using a color code.

A human-machine interface may include, among other possibilities, a web browser and client application. Web browsers enable users to display and interact with media and other information typically embedded on a web page or a website. A client application allows a user to interact with a server application from a server system or a web server.

### BRIEF DESCRIPTION OF THE DRAWINGS

In the following, the present disclosure is further described with reference to the enclosed figures:

FIG. 1 is a flow diagram of an example method for determining if a crop plant had been grown on at least one agricultural field during a previous growing period;

FIG. 2 is a schematic illustration of a field to be analyzed, and of an ensemble of fields to be analyzed

FIG. 3 is a schematic illustration of the time-resolved pattern of a vegetation index useful for identifying a crop plant growing on the field

FIG. 4 is a satellite picture containing augmented reality information on agricultural fields on which a crop plant of interest had been grown during a previous growing period

### DETAILED DESCRIPTION OF EMBODIMENT

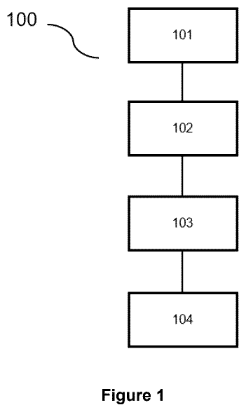

FIG. 1 is a flow diagram of an example method (100) for determining if a crop plant has been grown on at least one agricultural field during a previous growing period. The crop plant may for example be oilseed rape of the Clearfield product series of BASF, which has an increased tolerance against the herbicide product imazamox. Accordingly, a farmer can use imazamox to control unwanted vegetation on the agricultural field while not damaging the crop plants. Seeds of Clearfield oilseed rape are produced on agricultural fields and should not be contaminated by seeds of oilseed rape that do not have an enhanced imazamox resistance since any plants grown for these seeds would be strongly affected by imazamox treatments of a farmer and reduce the yield accordingly.

In a first step (101), historic satellite imaging data of at least one agricultural field from at least one previous growing period is provided to a processing unit. The satellite imaging data is typically retrieved from a server over the internet, for example via an API interface. The satellite imaging data may relate to only one field of interest, where it is to be evaluated if plant propagation material is to be produced. It may of course also relate to more agricultural fields within a given geographic area, such as within a given radius around the field of interest, or at a given radius around a city, a farm etc. The field of interest, or the geographic area of interest may be entered by a user, or it may be automatically determined automatically by using a positioning signal such as a GPS signal or a mobile phone positioning signal. For example, imaging data for agricultural fields within a given radius around a positioning signal can be retrieved.

The imaging data is historic imaging data of a previous growing period, such as last year, or the last three years. Historic satellite imaging data are available for many regions and saved on publicly accessible servers. The accuracy of the inventive method (100) is increased if imaging data of more than one previous growing period is used, wherein the highest impact is to be expected from the last growing period.

The imaging data may be a single satellite picture, or it may be a time-series of imaging data over at least one growing period, such as at least two satellite pictures per growing period. The accuracy of the inventive method (100) increases if more imaging data per growing period is provided.

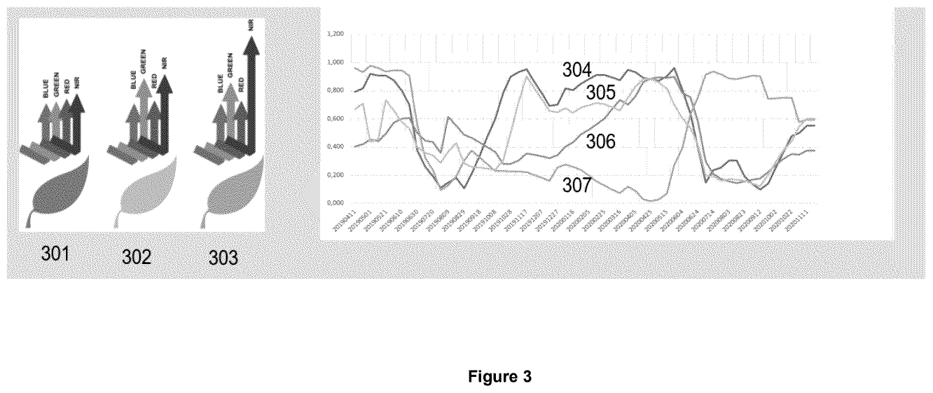

In a next step b (102), the processing unit determines from the imaging data if the crop plant has been grown on at least one field in at least one previous growing period. To this end, the processing unit may classify the satellite imaging data according to the type of crop plant. As outlined above, this may be achieved by various statistical methods, for example by using a machine-learning-based model. Such machine-learning-based models are typically obtainable by using annotated satellite imaging data as a training dataset, wherein the annotation is based on ground truth data collected by farmers, or agronomic advisors. The modelling and classification will be discussed and illustrated by FIG. 3. The model may use the raw imaging data as input, or it may use data with reduced complexity, such as vegetation index data, such as the NDVI index.

In a next step c (103), the processing unit provides the determined information of step b). In one embodiment, the term “providing” refers to the generation of an output that is presented by a human-machine-interface, such as a personal computer, a mobile phone, or a tablet. The human-machine interface may show the information on a special application such as Xarvio, on a web-browser software and the like. Accordingly, the term providing means the generation of an output signal to initiate the presentation of the information by a human-machine interface. In another embodiment, the term “providing” refers to the initiation of a selection step d (104) of selecting, based on the provided information, at least one suitable agricultural field for production of plant propagation material, wherein the crop plant has not been grown on the at least one agricultural field for at least one previous growing period. The selection is typically done by the same processing unit as for steps b) and c) (102, 103), but it may also be achieved by a different processing unit or even the user. The selection may be performed based on the classification of the at least one agricultural field(s) in step c (103), and, in case more than one field is analyzed, based on the relative location of the fields to each other.

If one field of interest is analyzed, the classification of said field will be either a crop plant that may cause contamination of the propagation material to be produced had been grown on the field during at least one previous growing period (“red”) or not (“green”). Accordingly, the selection would result in the selection of the field (“green”) or the field would be dismissed as being not suitable (“red”).

If more than one field of interest is analyzed, each of the fields would first be analyzed if a crop plant that may cause contamination of the propagation material to be produced has been grown on each of these fields during at least one previous growing period or not. In addition, the selection step (104) may take into account for each field the result of adjacent or close-by fields to further reduce the risk of contamination. For example, all adjacent fields and optionally fields within a radius of 3 kilometers may be taken into account. The radius covering other fields may be automatically adaptable according to an acceptable risk level. For example, the user may define a probability of contamination, which probability will be converted into a radius for fields to be accounted for in the analysis of an agricultural field of interest. The risk may typically be lower for fields that are further remote than for closer distances or even adjacent fields, such as projected by an exponential risk-distance-dependency. If more than one field is to be analyzed, the selection process (104) is typically not performed by a human user, but by a processing unit since complex risk scoring calculations are required.

The selected fields may then be presented by a human-machine-interface, such as a personal computer, a mobile phone, or a tablet. The human-machine interface may show the information on a special application such as Xarvio, on a web-browser software and the like. Accordingly, the processing unit would generate an output signal to initiate the presentation of the information by a human-machine interface. The user may then take an informed decision which of the fields that are pre-selected by the processing unit—based on the risk of contamination—should be picked for producing the plant propagation material.

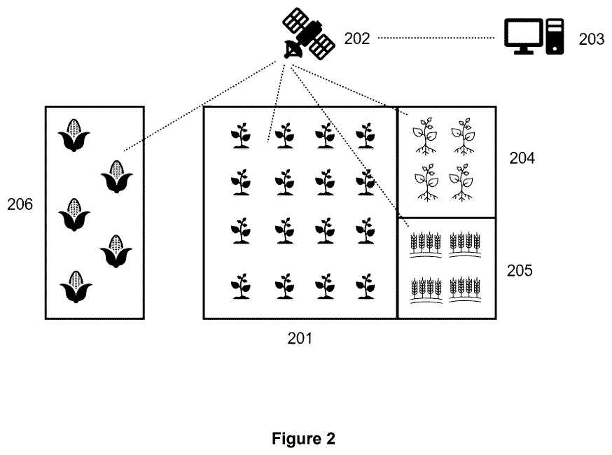

FIG. 2 shows a schematic representation of fields (201, 204-206) for which historic satellite imaging data may be collected. On each of the fields, a different crop had been grown in a previous growing period, such as last year. For example, oilseed rape had been grown on field (201), pea plants had been grown on a first adjacent field (204), ray had been grown on a second adjacent field (205), and corn had been grown on remote field (206). Satellite imaging data of the geographic area where the fields are located are collected and typically stored on a server (203) or in a cloud environment, where it is accessible to the public and can be used in the inventive method.

For example, a user may define a field, several fields, or a geographic area where Clearfield corn should be produced. The processing unit will then initiate a process to receive historic satellite imaging data of said geographic area. It will then determine for each of the fields or for each of the fields within said geographic area if Zea mays had been grown on said field during a previous growing period. Said information will then either be presented to the user directly, or it will be used in a further analysis step in which suitable fields for the production of Clearfield corn are automatically selected. The selection will of course take into account the result of the determination step b) for said field, but it may typically also account for the risk of contamination from other fields.

If, for example, Clearfield corn should be produced, the risk of contamination with pollen of other lines of Zea mays should be reduced as far as possible to protect the herbicide-tolerant genotype of the F1-generation. Pollen of Zea mays is primarily transported by wind and can only be transported over relatively short distances, which may be accounted for in selection step d). Pollen of other plants, like oilseed rape, is transported by insects, such as bees, and can thus be transported over longer distances, such as several kilometers. Accordingly, if seeds of a Clearfield line of Zea mays is to be produced on a field (201), imaging data as captured by a satellite (202) during at least one previous growing period for said field (201) and optionally also for adjacent fields (204), (205) and remote fields (206) may be used, wherein the distance to the field of interest (201) may be defined by the distance, and wherein the distance may be a result of a risk-scoring analysis. Typically, the risk of contamination will be very low if the remote field (206) is at least one kilometer away of field (201) and will become higher the closer the fields are.

Accordingly, the selection process will take into account determined information of step b) for fields that are within a given radius around a field (201), wherein the radius depends on a pre-determined risk level. Usually, however, adjacent fields will be taken into account independent of the defined risk level since the risk of contamination would not be tolerable.

Accordingly, the selection step d) would typically take into account the determined information of step b) at least for the field that should be evaluated (201) and the adjacent fields (204, 205). For example, if a Clearfield line of oilseed rape should be produced on field (201), and the determination in step b) would classify the field as having had oilseed rape grown on the field in a previous growing period, such field (201) would of course not be qualified to grow the Clearfield oilseed rape line since the probability of contamination from not harvested seeds of the previous season would be rated as high.

Equally, if it is to be analyzed if a field (204) would be suitable for production of Clearfield oilseed rape, the processing unit would take into account the classification result of agricultural field (201), and, since the fields are directly adjacent fields, would not select field (204) as suitable for production. The probability would be estimated to be very high that seeds of oilseed rape of a non-Clearfield line would have remained in the soil of field (201), which would germinate and grow to oilseed rape plants in the season to come. The pollen of such non-Clearfield plants would have a high probability of being transported by insects to field (204) and cause detrimental crossing events with the Clearfield plants, causing a seed product with individual seeds having an undesired genotype.

FIG. 3 shows the development of the NDVI index over a season. The NDVI vegetation index takes into account the relation of intensity of different spectral areas in an image, in particular the near infrared and the visible red-light parts of the spectrum and puts them into relation. The NDVI index of a plant varies during the season as displayed in the left window of FIG. 3. For a green, healthy leaf (303), the NIR intensity is rather high as compared to the red-light parts of the spectrum. This is different for young leaves (302) or brown leaves (301). On the right-hand side of FIG. 3, time-resolved data series of NDVI values over one season are shown for different crops plants (304, 305, 306, 307). Depending on the growth cycle of the plant, the NDVI has a very specific pattern for each plant. For example, some crop plants start to germinate and grow at a different point in time during the season. As can be seen from curve (304), the onset of the curve is rather early and abrupt at the beginning of the winter season, whereas curve (306) would rise slowly and steadily during the winter season. Finally, NDVI curve (307) would only raise in the summer months beginning of June. Whereas the distinct patterns for different crop plants is only shown for the NDVI index, it is also present in other vegetation indexes like the LAI index.

These patterns can be used to identify the type of crop plant grown on a field. It is not necessary to record the entire time-resolved pattern of the indexes, but the more datapoints are available the higher the accuracy of the information will be. Typically, not only one vegetation index is used as input factor, but an array of vegetation index factors. In case a machine-learning model is used, it is also possible to use the entire satellite imaging data as input data without any reduction of complexity. As mentioned earlier, an annotated form of the satellite imaging data may be used as training dataset to generate a machine-learning model. The annotation can be achieved be recording farmer data, such as with a customer frontend tool like the BASF Xarvio suite. It may also be achieved by using observation data obtained by sales representatives. The annotated training data may be used for supervised machine-learning approaches. For example, training data may comprise satellite images of a geographic area, wherein certain agricultural fields have been annotated with the type of crop growing on said field, and the time during the season when the image was captured. Alternatively, the training data may comprise one or more vegetation indexes annotated with the type of crop plant and the point in time during the season when the image was captured, preferably wherein the imaging data is time-resolved and contains at least imaging data of two points in time during the season. The machine-learning tools typically use a loss-function to generate a model that describes the training data in the best way possible. Typically, validation data is used to avoid overfitting. The thus obtained model can then be used to analyze newly captured satellite imaging data.

If no machine-learning approach is used, it may be advisable to generate calibration curves of vegetation indexes from annotated training data, such as by determining the mean of various curves captured for the same crop plant. The calibration curves may then be used in a regression approach to classify new data according to the pre-defined calibration curves. Typically, this is achieved by minimizing the deviation of the newly measured curved from the calibration curves and classifying the field according to the fit with the smallest deviation. Accordingly, the captured satellite imaging data can be analyzed to classify the crop plants grown on the agricultural field during a previous growing period.

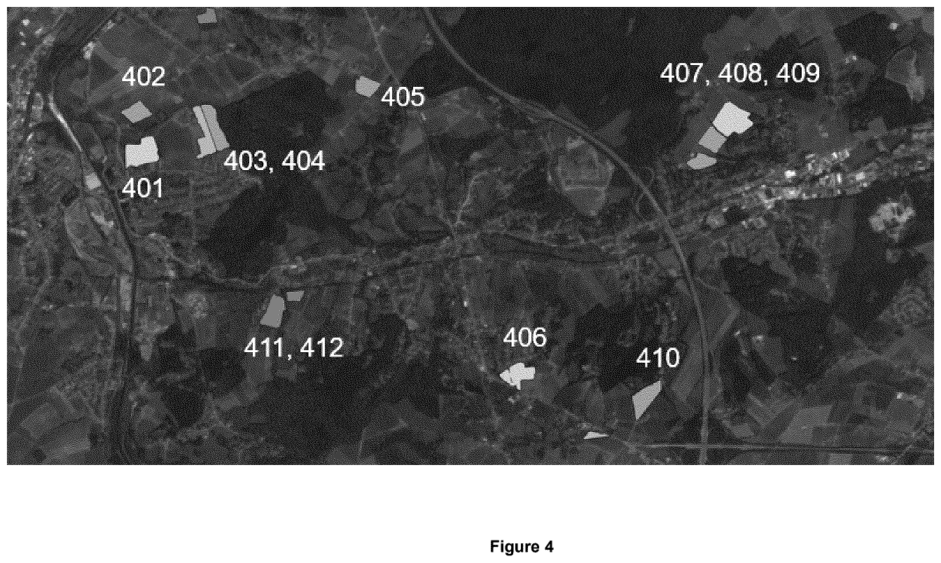

FIG. 4 shows a satellite image of a geographical area of interest with certain highlighted agricultural fields (401-412). Such presentation of information may be displayed to a user on a computer or a smart phone to inform the user on the suitability of certain fields to generate plant propagation material of a particular crop plant. The fields may be highlighted in shades of gray, or by colors indicating the suitability of the field to produce plant propagation material of a particular crop plant.

For example, the user may have input the type of crop plant that should be used to produce a certain plant propagation material in a geographic area. The inventive method may then determine if said crop plant had already been grown on an agricultural field during a previous growing period and present that information to the user via a human-machine interface such as a computer screen. The information may also contain information on the likelihood of the identification of the crop plant. For example, if a regression has a high deviation, such as a low R2 value, this may be reflected by different shades of color of the highlighted fields. By way of illustration, a field may be colored green if the system has not found that the crop plant of interest had been grown on the field over a previous growing period. But if the regression was rather poor, the inventive system may determine that the accuracy of this information is not high, which may be reflected by a pale shade of green. Likewise, if the system has found that the crop plant had been grown on the field during a previous growing period, it may represent the estimated accuracy of this information by different shades of red.

In case the method comprises step d) of selecting suitable field(s) for the production of the plant propagation material, the highlighting of the fields may also reflect the risk of contamination from other fields in the vicinity. Accordingly, the shade of green or red, indicating the suitability of the field for producing a particular type of plant propagation material, may be influenced by the classification of fields within a given radius. As mentioned above, the radius would reflect the level of acceptable risk to the farmer, and the type of crop plant, i.e. the way of transport of pollen such as by wind or by insects. The information on the dependency of the risk of contamination and the distance between two fields for a given type of crop is typically stored at a memory communicatively coupled to the processing unit. Upon input by the user which type of crop plant should be used for production, the processing unit would access the memory storage and select the radius for the risk assessment in step d) according to pre-defined acceptable risk scores. Such risk scores may of course also be entered by the user, which may depend on the necessity of producing a pure product.

Aspects of the present disclosure relates to computer program elements configured to carry out steps of the methods described above. The computer program element might therefore be stored on a computing unit of a computing device, which might also be part of an embodiment. This computing unit may be configured to perform or induce performing of the steps of the method described above. Moreover, it may be configured to operate the components of the above-described system. The computing unit can be configured to operate automatically and/or to execute the orders of a user. The computing unit may include a data processor. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick, a downloadable executable or the like, is presented wherein the computer readable medium has a computer program element stored on it which computer program element is described by the preceding section. A computer program may be stored and/or distributed on a suitable medium, such as an optical storage medium or a solid-state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for selecting at least one agricultural field for production of plant propagation material of a crop plant comprising the steps:
a) providing historic satellite imaging data of at least one agricultural field from at least one previous growing period to a processing unit;
b) determining, based on the imaging data, if the crop plant was grown on the at least one field in at least one previous growing period by the processing unit;
c) providing information by the processing unit if the crop plant had been grown on the at least one field in at least one previous growing period; and
d) selecting, based on the provided information, at least one suitable agricultural field for production of plant propagation material, wherein the crop plant has not been grown on the at least one agricultural field for at least one previous growing period.

2. The method of claim 1, further comprising step a1) after step a) or step b) of determining based on the imaging data field boundaries by the processing unit, using a field boundary detection model, wherein the field boundary detection model is a machine-learning.

3. The method of claim 1, wherein the historic satellite imaging data comprises time-resolved imaging data over the at least one previous growing period.

4. The method of claim 3, wherein step b) comprises determining from the imaging data time-resolved vegetation index data selected from Normalized Difference Vegetation Index (NDVI) Data and/or Leaf Area Index (LAI) Data, Normalized Difference Water Index (NDWI), Enhanced Vegetation Index (EVI) Data and/or any other vegetation based indices data.

5. The method of claim 4, wherein step b) comprises classifying the at least one field by crop plant according to the time-resolved vegetation index data.

6. The method of claim 5, wherein the classification is performed by using a classification model, wherein the classification model is obtainable by machine-learning.

7. The method of claim 6, wherein the machine-learning is supervised machine-learning, wherein the training data is obtained by annotation of satellite imaging data with ground truth data.

8. The method according to claim 1, wherein the imaging data is obtained by using Synthetic Aperture Radar (SAR), or Light Detection and Ranging (LIDAR) via satellites

9. The method according to claim 1,
wherein imaging data of at least two agricultural fields is provided, and wherein at least two of the agricultural fields are adjacent fields, or wherein the boundaries of at least two of the agricultural fields are up to 10 km apart; and
wherein the selection of step d) is also based on the information on the presence of the crop plant at the at least one second field during a previous growing period.

10. The method of claim 9, wherein imaging data of one agricultural field and all adjacent fields is provided, and wherein the selection of step d) is based on the information on the presence of the crop plant at the field and all adjacent fields during a previous growing period.

11. The method of claim 1, wherein the imaging data is provided for at least the two previous growing periods.

12. (canceled)

13. A system for selecting an agricultural field for production of plant propagation material of a crop plant, the system comprising
a) a receiving unit configured to receive historic imaging data of at least one agricultural field from at least one previous growing period;
b) a processing unit configured to
determine, based on the imaging data, if the crop plant had been grown on the at least one field in at least one previous growing period;
provide information if the crop plant had been grown on the at least one field in at least one previous growing period; and
select, based on the provided information, at least one suitable agricultural field for production of plant propagation material, wherein the crop plant has not been grown on the at least one agricultural field for at least one previous growing period.

14. A computer program element with instructions, which, when executed on computing devices of a computing environment, is configured to carry out the steps of the method according to claim 1 in a system comprising
a) a receiving unit configured to receive historic imaging data of at least one agricultural field from at least one previous growing period;
b) a processing unit configured to
determine, based on the imaging data, if the crop plant had been grown on the at least one field in at least one previous growing period; and
provide information if the crop plant had been grown on the at least one field in at least one previous growing period; and
select, based on the provided information, at least one suitable agricultural field for production of plant propagation material, wherein the crop plant has not been grown on the at least one agricultural field for at least one previous growing period.

15. A computer readable medium having stored the computer program element of claim 14.
